(19) United States
(12) Patent Application Publication
(10) Pub. No.: US 2026/0169355 A1
(43) Pub. Date: Jun. 18, 2026

(54) FINDER AND IMAGING APPARATUS

(71) Applicant: FUJIFILM Corporation, Tokyo (JP)

(72) Inventors: Shunsuke MIYAGISHIMA, Saitama (JP); Takashi AOKI, Saitama (JP); Yuya HIRAKAWA, Saitama (JP); Yoichi IWASAKI, Saitama (JP); Hiroki SAITO, Saitama (JP)

(73) Assignee: FUJIFILM Corporation, Tokyo (JP)

(21) Appl. No.: 19/408,401

(22) Filed: Dec. 4, 2025

(30) Foreign Application Priority Data
Dec. 16, 2024 (JP) 2024-219707

(51) Int. Cl. G03B 13/06; G02B 5/30; G02B 27/28

(52) U.S. Cl. CPC G03B 13/06; G02B 5/3016; G02B 27/283

(57) ABSTRACT

To provide a finder and an imaging apparatus having good visibility. A finder includes a first optical system, a second optical system, and a polarizer. The second optical system includes a first polarizer that transmits light in a first polarization direction, and an optical member that controls a polarization direction of the light transmitted through the first polarizer. The polarizer reflects at least a part of light passing through the first optical system, and transmits light in a second polarization direction in light passing through the second optical system.

### CROSS-REFERENCE TO RELATED APPLICATION

The present application claims priority under 35 U.S.C § 119(a) to Japanese Patent Application No. 2024-219707 filed on Dec. 16, 2024, which is hereby expressly incorporated by reference, in its entirety, into the present application.

### BACKGROUND OF THE INVENTION

### 1. Field of the Invention

The present invention relates to a finder and an imaging apparatus equipped with a finder.

### 2. Description of the Related Art

As a hybrid view finder (HVF), there is a known finder having both functions of an optical view finder (OVF) and an electronic view finder (EVF) (for example, WO2022/196187A, WO2012/035820A, and WO2019/087930A).

### SUMMARY OF THE INVENTION

One embodiment according to the technology of the present disclosure provides a finder and an imaging apparatus with good visibility.
[1] A finder including a first optical system, a second optical system including a first polarizer that transmits light in a first polarization direction, and an optical member that controls a polarization direction of the light transmitted through the first polarizer, and a polarizer that reflects at least a part of light passing through the first optical system and transmits light in a second polarization direction in light passing through the second optical system.
[2] The finder according to [1], in which the optical member may be a liquid crystal member.
[3] The finder according to [1] or [2], in which the first polarizer and the polarizer may have a relationship in which a transmittance of the light in the second polarization direction is equal to or less than a threshold value.
[4] The finder according to any one of [1] to [3], in which the first polarizer and the polarizer may have a relationship in which the first polarization direction intersects with the second polarization direction.
[5] The finder according to any one of [1] to [4], in which the polarizer may enable a direction of a transmission axis of the polarizer with respect to a transmission axis of the first polarizer to be relatively adjusted.
[6] The finder according to [5], in which the polarizer may be rotatable around an optical axis of the second optical system to adjust the direction of the transmission axis of the polarizer with respect to the transmission axis of the first polarizer.
[7] The finder according to any one of [1] to [6], in which the second optical system may include an optical system that has a negative power, and the first polarizer and the optical member may be disposed closer to an eyepiece side than the optical system that has the negative power.
[8] The finder according to any one of [1] to [7], in which the second optical system may include an optical system that has a positive power, and the first polarizer and the optical member may be disposed closer to an objective side than the optical system that has the positive power.
[9] The finder according to any one of [1] to [8], in which the second optical system may further include a first quarter-wave plate and a second quarter-wave plate, and at least one optical element may be disposed between the first quarter-wave plate and the second quarter-wave plate.
[10] The finder according to [9], in which the optical element disposed between the first quarter-wave plate and the second quarter-wave plate may be an optical element made of a resin.
[11] The finder according to any one of [1] to [10], in which the second optical system may further include a second polarizer that transmits the light in the second polarization direction, and the optical member may be disposed between the first polarizer and the second polarizer.
[12] The finder according to any one of [1] to [11], in which the optical member may enable the polarization direction to be controlled for a plurality of regions.
[13] The finder according to any one of [1] to [12], in which the polarizer may be configured of a polarization beam splitter.
[14] The finder according to any one of [1] to [13] further including a display device, in which light emitted from the display device may be incident on the first optical system.
[15] An imaging apparatus including the finder according to any one of [1] to [14].

### BRIEF DESCRIPTION OF THE DRAWINGS

FIG. 1 is a schematic configuration diagram showing an embodiment of an HVF.

FIG. 2 is a diagram representing a change in brightness of an object image observed through an OVF in a case where a transmittance is changed.

FIGS. 3A and 3B are diagrams showing an example of a case where the transmittance is partially controlled.

FIGS. 4A and 4B are diagrams showing an example of display of an EVF.

FIGS. 5A and 5B are diagrams showing an example of superimposed display in the OVF.

FIGS. 6A and 6B are diagrams showing an example of display of the OVF in which the transmittance is changed.

FIG. 7 is a diagram showing an example of an arrangement of a liquid crystal panel in a case where an objective optical system includes an optical system having a negative power.

FIG. 8 is a diagram showing an example of the arrangement of the liquid crystal panel in a case where the objective optical system includes an optical system having a positive power.

FIG. 9 is a diagram showing an example of a configuration of the HVF in a case where a resin lens is used for the objective lens group.

FIG. 10 is a diagram showing another example of a configuration for realizing a function of an electronic variable ND filter.

FIG. 11 is a front view of an embodiment of a digital camera.

FIG. 12 is a rear perspective view of the digital camera shown in FIG. 11.

FIG. 13 is a block diagram showing an electric configuration of the digital camera.

### DESCRIPTION OF THE PREFERRED EMBODIMENTS

Preferred embodiments of the present invention will be described below with reference to accompanying drawings.

### Finder

A case where the present invention is applied to a hybrid view finder (HVF) will be described as an example.

As described above, the HVF is a finder having both functions of an optical view finder (OVF) and an electronic view finder (EVF).

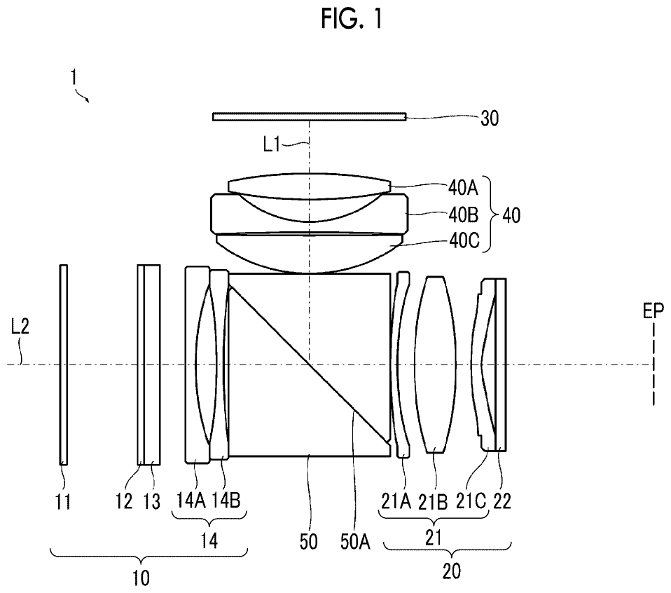

FIG. 1 is a schematic configuration diagram showing an embodiment of the HVF to which the present invention is applied.

### Overall Configuration of HVF

As shown in FIG. 1, an HVF 1 comprises an objective optical system 10, an eyepiece optical system 20, a finder display (display element) 30, a display element-side optical system 40, a beam splitter 50, and the like.

### Objective Optical System

The objective optical system 10 comprises, in order from an objective side, a quarter-wave plate 11, a polarizer 12, a liquid crystal panel 13, an objective lens group 14, and the like, along a second optical axis L2. In the present embodiment, the objective optical system 10 is an example of a second optical system. Further, the second optical axis L2 is an example of an optical axis of the second optical system.

The quarter-wave plate 11 converts linear polarization into circular polarization. An example of a scene in which light of linear polarization is incident on the objective optical system 10 includes a scene in which a liquid crystal display (LCD) is observed as a subject. In such a case, the linear polarization is converted into the circular polarization. Accordingly, it is possible to suppress a change in appearance of the OVF due to a finder orientation (for example, difference between vertical-position imaging and horizontal-position imaging).

The quarter-wave plate 11 is disposed, for example, in a finder window portion of an imaging apparatus equipped with the HVF 1. The quarter-wave plate 11 can also be omitted.

The polarizer 12 causes light polarized in a specific polarization direction to transmit. The polarization direction of the light transmitted through the polarizer 12 is referred to as a first polarization direction. In the present embodiment, the polarizer 12 is an example of a first polarizer.

The liquid crystal panel 13 controls the polarization direction of the light transmitted through the polarizer 12. The liquid crystal panel 13 includes a liquid crystal layer (not shown), and controls the polarization direction of the transmitted light with the liquid crystal layer. Specifically, an orientation of liquid crystal molecules constituting the liquid crystal layer is electronically controlled to control the polarization direction of the transmitted light. The liquid crystal panel 13 of the present embodiment has a configuration in which the polarization direction of the transmitted light can be controlled for each of regions (pixels) divided in a matrix shape. That is, the liquid crystal panel 13 has a configuration in which the polarization direction can be controlled for each region in regions through which the light is transmitted (configuration in which the polarization direction can be controlled for a plurality of regions). Since the configuration of this type of liquid crystal panel is known, a description of details thereof will be omitted. As an example, the liquid crystal panel 13 of the present embodiment has a configuration in which an alignment film, transparent electrodes, and a transparent substrate are disposed with the liquid crystal layer interposed therebetween, and a voltage is applied between the transparent electrodes to control the orientation of the liquid crystal molecules. That is, the polarization direction of the transmitted light is controlled. In the present embodiment, the liquid crystal panel is an example of an optical member and an example of a liquid crystal member.

As an example, in the present embodiment, the polarizer 12 is configured to be disposed on the objective side of the liquid crystal panel 13, and be integrated with the liquid crystal panel 13. That is, the polarizer 12 and the liquid crystal panel 13 are configured as an integrated body.

The objective lens group 14 is composed of at least one lens. As an example, in the present embodiment, the objective lens group 14 is composed of two lenses of a first objective lens 14A and a second objective lens 14B.

### Eyepiece Optical System

The eyepiece optical system 20 guides, to an eye point EP of an observer, the light from the objective optical system 10 and the light from the display element-side optical system 40, via the beam splitter 50. The eyepiece optical system 20 comprises, in order from the objective side, an eyepiece lens group 21, a cover glass 22, and the like, along the second optical axis L2.

The eyepiece lens group 21 is composed of at least one lens. As an example, in the present embodiment, the eyepiece lens group 21 is composed of three lenses of a first eyepiece lens 21A, a second eyepiece lens 21B, and a third eyepiece lens 21C.

The cover glass 22 is disposed, for example, in a finder eyepiece portion of the imaging apparatus equipped with the HVF 1.

### Finder Display

The finder display 30 is a display device for an image in the finder. As an example, in the present embodiment, the finder display 30 is configured of an organic EL display (organic light emitting diodes: OLED). A configuration of the finder display 30 is not limited thereto, and the finder display 30 can be configured of, for example, a transmissive LCD including a backlight. The finder display 30 is disposed on a first optical axis L1. The first optical axis L1 is orthogonal to the second optical axis L2.

### Display Element-Side Optical System

The display element-side optical system 40 has at least one lens, and guides the light from the finder display 30, which is the display element, to the beam splitter 50. As an example, in the present embodiment, the display element-side optical system 40 is composed of three lenses. The three lenses are disposed, from a finder display 30 side, in order of a first lens 40A, a second lens 40B, and a third lens 40C, along the first optical axis L1. In the present embodiment, the display element-side optical system 40 is an example of a first optical system.

### Beam Splitter

The beam splitter 50 superimposes the light from the objective optical system 10 and the light from the display element-side optical system 40, and guides the superimposed light to the eyepiece optical system 20. As an example, in the present embodiment, the beam splitter 50 is configured of a polarizing beam splitter (PBS), and the superimposition of light is performed by using polarization. That is, only light having a specific polarization state is selectively reflected or transmitted to perform the superimposition of light. In particular, in the present embodiment, the beam splitter 50 is configured of a cube-type dichroic polarization beam splitter. The cube-type beam splitter 50 is configured by bonding inclined surfaces of two right-angle prisms, and the light is branched by thin film coating on a boundary surface (bonding surface) thereof. The two prisms are bonded to each other by an adhesive or optical contact. The beam splitter 50 of the present embodiment has a function of reflecting S polarization and transmitting P polarization by dichroic coating on a boundary surface 50A. In the present embodiment, the beam splitter 50 is an example of a polarizer.

The beam splitter 50 is disposed at an intersection of the second optical axis L2 and the first optical axis L1. Further, the beam splitter 50 is disposed such that the boundary surface 50A is inclined by 45° with respect to the second optical axis L2 and the first optical axis L1. The objective optical system 10 and the eyepiece optical system 20 are disposed on the second optical axis L2 with the beam splitter 50 interposed therebetween. That is, the objective optical system 10 is disposed on the objective side of the beam splitter 50, and the eyepiece optical system 20 is disposed on an eyepiece side (eye point side).

An S polarization component is reflected by and a P polarization component is transmitted through the beam splitter 50, and the light that passes through the objective optical system 10 is guided to the eyepiece optical system 20.

On the other hand, the P polarization component is transmitted through and the S polarization component is reflected by the beam splitter 50, and the light that is emitted from the finder display 30 and passes through the display element-side optical system 40 is guided to the eyepiece optical system 20.

As a result, the light from the objective optical system 10 and the light from the finder display 30 are superimposed on each other in the beam splitter 50, and are guided to the eyepiece optical system 20. Further, accordingly, it is possible to observe an image in which both images are superimposed. That is, it is possible to observe an image in which screen display of the finder display 30 is superimposed on an object image by the OVF.

Here, the polarization direction of P-polarized light transmitted through the beam splitter 50 is referred to as a second polarization direction. A transmittance of the light in the second polarization direction changes depending on an orientation relationship between the polarization direction of the light transmitted by the polarizer 12 of the objective optical system 10 (first polarization direction) and the second polarization direction, and is the smallest in a case where the two directions are orthogonal to each other. Since the light in the second polarization direction turns into noise in a case where the EVF is used, it is desirable that the transmittance of the light in the second polarization direction is a value equal to or less than a threshold value at which the light therein does not turn into noise. That is, it is most desirable that the polarizer 12 and the beam splitter 50 have a relationship in which the polarization directions of the light transmitted through the polarizer 12 and the light transmitted through the beam splitter 50 are orthogonal to each other. Thus, in a case where the liquid crystal panel 13 is not provided, the light passing through the objective optical system 10 is reflected by the beam splitter 50. That is, the light is not incident on the eyepiece optical system 20. In the present embodiment, orthogonality is an example of intersection.

### Function of HVF

In the HVF 1 of the present embodiment configured as described above, the objective optical system 10, the beam splitter 50, and the eyepiece optical system 20 configure the OVF. Further, the finder display 30, the display element-side optical system 40, the beam splitter 50, and the eyepiece optical system 20 configure the EVF.

Further, in the HVF 1 of the present embodiment, the polarizer 12, the liquid crystal panel 13, and the beam splitter 50 configure an electronic variable ND (neutral density) filter. That is, the polarizer 12, the liquid crystal panel 13, and the beam splitter 50 function as a variable ND filter that can electronically adjust an amount of light. A mechanism of the electronic variable ND filter is as follows.

In the light incident on the polarizer 12, only the light polarized in the specific polarization direction (first polarization direction) transmits through the polarizer 12, and the rest is blocked.

The light transmitted through the polarizer 12 (light in the first polarization direction) is incident on the beam splitter 50 with the polarization direction controlled by the liquid crystal panel 13.

In a case where the polarization direction of the light incident on the beam splitter 50 matches the polarization direction of the light transmitted through the beam splitter 50, all the incident light transmits through the beam splitter 50. The polarization direction of the light transmitted through the beam splitter 50 is a P-polarized direction, which is the second polarization direction.

On the other hand, in a case where the polarization direction of the light incident on the beam splitter 50 is orthogonal to the second polarization direction, all the incident light is blocked (reflected) by the beam splitter 50.

Further, in a case where the polarization direction of the light incident on the beam splitter 50 is inclined by 45° with respect to the second polarization direction, half of the incident light transmits through the beam splitter 50.

In this manner, with the control of the polarization direction of the light incident on the beam splitter 50 by the liquid crystal panel 13, it is possible to adjust an amount of the light transmitted through the beam splitter 50. That is, it is possible to control the light transmittance.

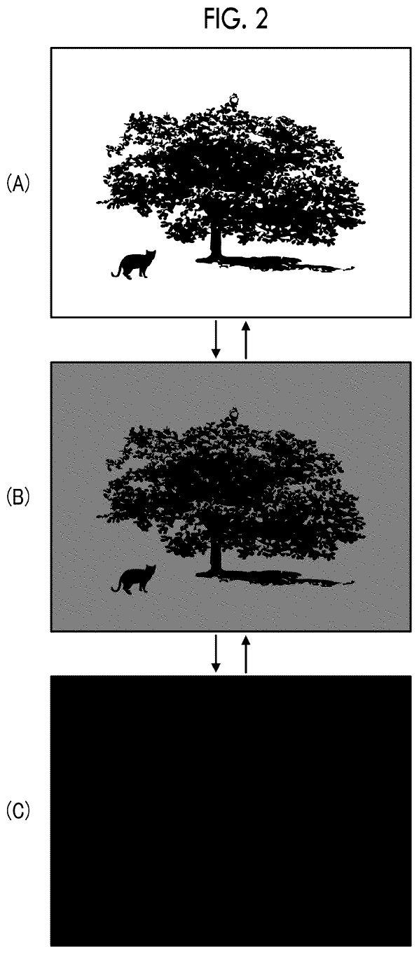

FIG. 2 is a diagram showing a change in brightness of the object image observed through the OVF in a case where the transmittance is changed.

(A) of FIG. 2 shows an example of the object image observed in a case where the transmittance is maximized.

With control of the polarization direction of the light to the second polarization direction by the liquid crystal panel 13, the transmittance is maximized.

(B) of FIG. 2 shows an example of the object image observed in a case where the transmittance is 50%.

With inclination of the polarization direction of the light by 45°with respect to the second polarization direction by the liquid crystal panel 13, the transmittance is 50%.

(C) of FIG. 2 shows an example of the object image observed in a case where the transmittance is minimized.

With control of the polarization direction of the light to a direction orthogonal to the second polarization direction by the liquid crystal panel 13, the transmittance is minimized. As an example, in the present embodiment, the transmittance is 0% (including a range that is recognized as substantially 0%). In the minimum transmittance, the light incident on the eyepiece optical system 20 is blocked.

In this manner, with the control of the polarization direction of the light by the liquid crystal panel 13, it is possible to control the transmittance of the light. Accordingly, it is possible to adjust the brightness of the object image observed through the OVF.

Further, in a case where the transmittance is minimized, the light can be blocked. The OVF is turned off by the light blocking. Therefore, the polarizer 12, the liquid crystal panel 13, and the beam splitter 50 function as the electronic variable ND filter and also function as a shutter (finder shutter).

As described above, the liquid crystal panel 13 of the present embodiment can control the polarization direction of the transmitted light for each of the regions (pixels) divided in a matrix shape. Therefore, it is possible to partially control the transmittance.

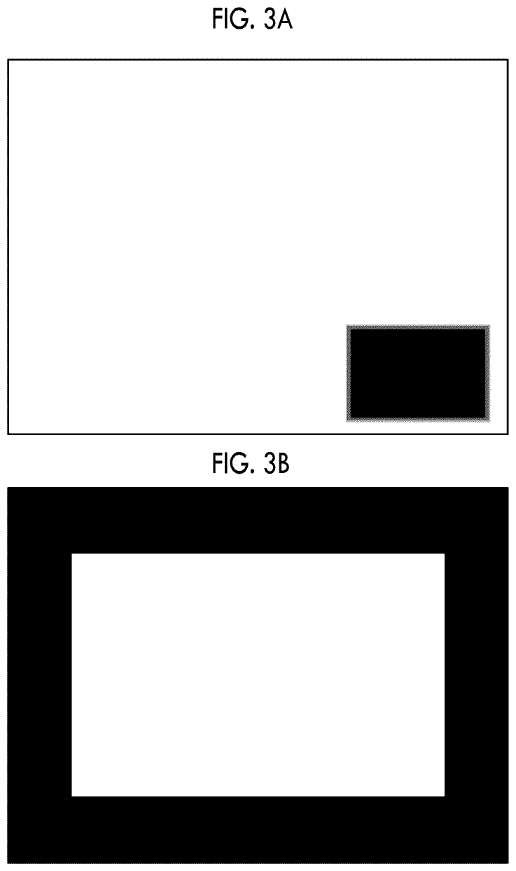

FIGS. 3A and 3B are diagrams showing an example of a case where the transmittance is partially controlled.

FIG. 3A is a diagram showing an example in a case where the transmittance of a part of a rectangular region in a lower right corner within a frame of the finder is minimized. In this case, the object image of the OVF is observed with the lower right corner region being blocked from light.

FIG. 3B is a diagram showing an example in a case where the transmittance of an edge portion within the frame of the finder is minimized. In this case, a periphery of the object image of the OVF is blocked from light in a frame shape, and only a central portion of the object image thereof is observed.

### Display of HVF

As Described above, HVF 1 can be used as the OVF or the EVF.

### Case of Being Used as EVF

In a case where the HVF 1 is used as the EVF, the finder shutter is closed. That is, the transmittance of the light from the objective optical system 10 is minimized (transmittance of 0%). Accordingly, the light from the objective optical system 10 is blocked by the beam splitter 50.

An image is displayed on the finder display 30 in a state where the finder shutter is closed. The light emitted from the finder display 30 is incident on the beam splitter 50 via the display element-side optical system 40. The S polarization component in the light incident on the beam splitter 50 is reflected by the beam splitter 50, and guided to the eyepiece optical system 20. The light guided to the eyepiece optical system 20 passes through the eyepiece optical system 20, and is incident on the eye point EP. Accordingly, the display of the finder display 30 is observed at the eye point EP.

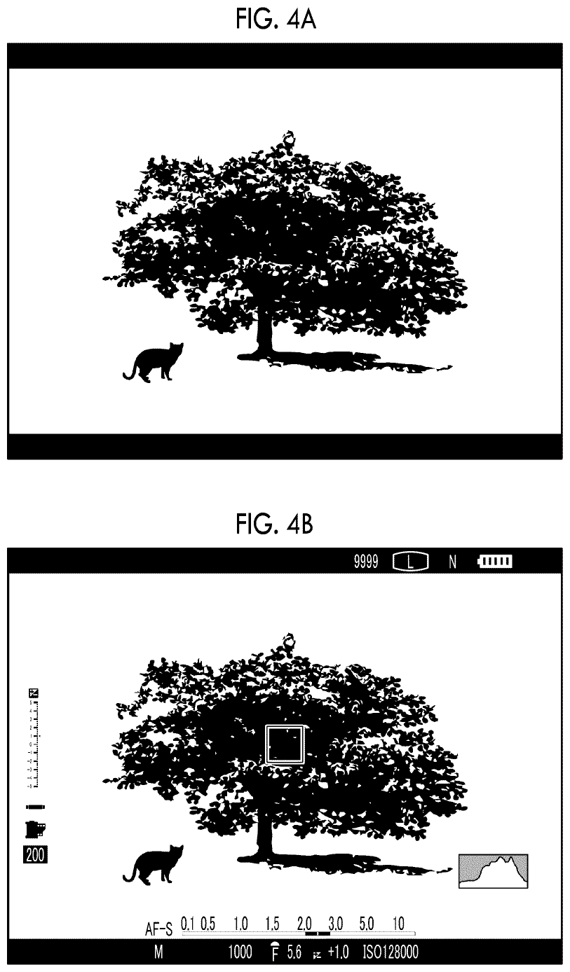

FIGS. 4A and 4B are diagrams showing an example of the display of the EVF.

In the EVF, the image displayed on the finder display 30 is observed. FIG. 4A shows an example of a case where a live-view image is displayed. FIG. 4B shows an example of a case where predetermined imaging information is displayed, in addition to the live-view image.

### Case of Being Used as OVF

In a case where the HVF 1 is used as the OVF, the transmittance of the light from the objective optical system 10 is set to a predetermined value (excluding 0%). As an example, the transmittance is set to be maximum. Accordingly, the light from the objective optical system 10 is guided to the eyepiece optical system 20 with a maximum transmittance. The light guided to the eyepiece optical system 20 passes through the eyepiece optical system 20, and is incident on the eye point EP. Accordingly, the object image of the subject is observed at the eye point EP.

In a case where the image is displayed on the finder display 30 during the use of the OVF, the display of the finder display 30 is displayed in a state of being superimposed on the object image of the subject observed through the OVF. Specifically, in a case where the finder display 30 is displayed, the light from the finder display 30 is superimposed on the light from the objective optical system 10 in the beam splitter 50, and is incident on the eyepiece optical system 20. As a result, the display of the finder display 30 is displayed in a state of being superimposed on the object image of the subject observed through the OVF.

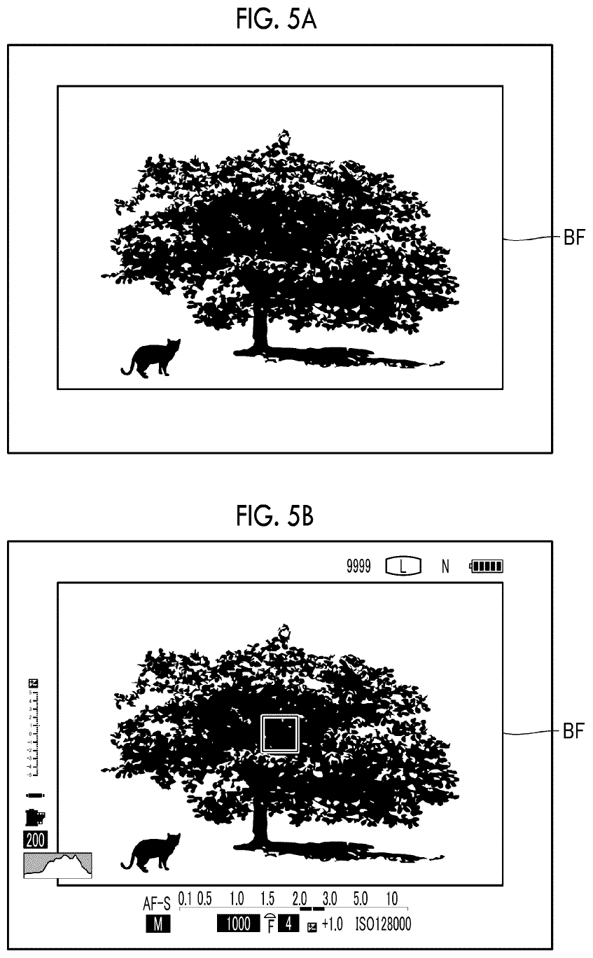

FIGS. 5A and 5B are diagrams showing an example of superimposed display in the OVF.

FIG. 5A shows an example of a case where a bright frame BF is displayed in a state of being superimposed on the object image of the subject observed through the OVF.

FIG. 5B shows an example of a case where predetermined imaging information is displayed, in addition to the bright frame BF.

With the control of the liquid crystal panel 13 to control the transmittance of the light from the objective optical system 10, it is possible to adjust the brightness of the object image of the subject observed through the OVF.

The transmittance is manually or automatically adjusted. In a case of the automatic adjustment, a photometry unit that measures brightness of the subject is separately provided, and the transmittance is adjusted based on a photometry result of the photometry unit. In this case, the transmittance is lower as the brightness of the subject is higher. That is, the transmittance is decreased in a bright environment, and the transmittance is increased in a dark environment. Accordingly, it is possible to ensure good visibility regardless of the ambient brightness.

It is preferable that the brightness of the image to be superimposed is also adjusted according to the brightness of the subject. That is, it is preferable to control an amount of light of the finder display 30 according to the brightness of the subject.

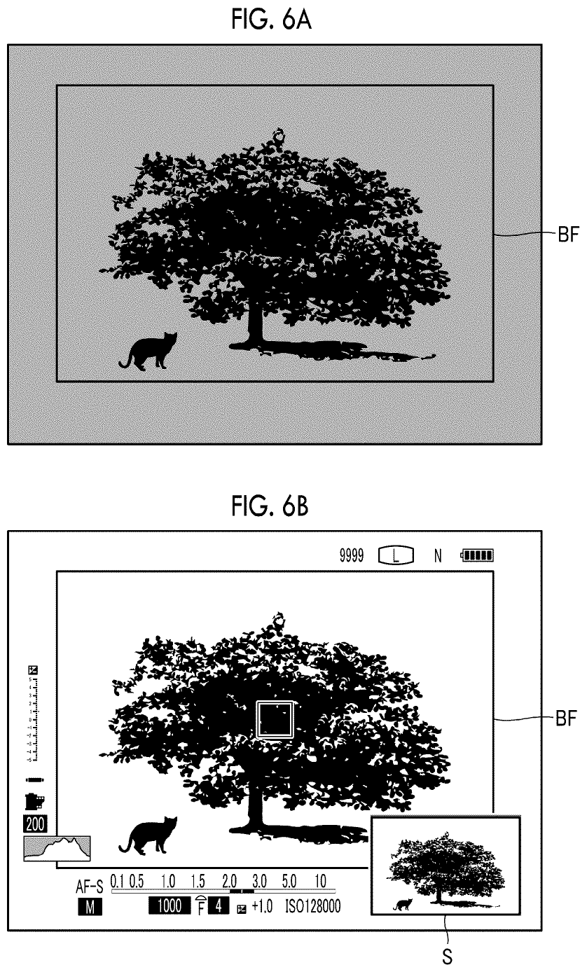

FIGS. 6A and 6B are diagrams showing an example of the display of the OVF in which the transmittance is changed.

FIG. 6A shows an example of display in which the transmittance is reduced as compared with the display shown in FIG. 5A. In this case, the display of the OVF darkens.

FIG. 6B shows an example of a case where a display region (small window) S of the EVF is provided within the frame of the finder and the image of the EVF (for example, live-view image) is displayed in the display region S. FIG. 6B shows an example in a case where the display region S is disposed at a position of a lower right corner within the frame of the finder. In this case, the transmittance of the display region S is set to be minimum (refer to FIG. 3A). Accordingly, in the display region S, the light of the OVF is blocked, and thus it is possible to improve the visibility of the image to be displayed in the display region S.

### Modification Example of Finder

### Adjustment Mechanism

In the HVF 1 of the above embodiment, the polarization direction (second polarization direction) of the light transmitted through the beam splitter 50 (P-polarized light) is set in a relationship of being orthogonal to the polarization direction (first polarization direction) of the light transmitted through the polarizer 12. Therefore, it is preferable that the relationship between the two directions can be finely adjusted after attachment. That is, it is preferable that an orientation of a transmission axis of the beam splitter 50 with respect to a transmission axis of the polarizer 12 can be relatively adjusted.

As an example, a configuration is employed in which the beam splitter 50 is held to be rotatable around the second optical axis L2, and the inclination of the beam splitter 50 around the second optical axis L2 can be finely adjusted (configuration in which a direction of the transmission axis can be adjusted around the optical axis). In this case, the beam splitter 50 is rotated around the second optical axis L2 to adjust the orientation of the transmission axis of the beam splitter 50 with respect to the transmission axis of the polarizer 12. After the adjustment, the beam splitter 50 is fixed.

In addition, a configuration may be employed in which the polarizer 12 and the liquid crystal panel 13 are held to be rotatable around the second optical axis L2, and the inclination of the polarizer 12 and the liquid crystal panel 13 around the second optical axis L2 can be finely adjusted. Further, a configuration may be employed in which both the polarizer 12 and the beam splitter 50 are held to be rotatable, and the inclination of both the polarizer 12 and the beam splitter 50 around the second optical axis L2 can be finely adjusted.

### Polarizer and Beam Splitter

In the HVF 1 of the above embodiment, the polarizer 12, the liquid crystal panel 13, and the beam splitter 50 configure the electronic variable ND filter. In this case, it is preferable that a combination of the polarizer 12 and the beam splitter 50 realizes the transmittance of 0%. That is, it is preferable that the amount of transmitted light is as close to zero as possible. Accordingly, it is possible to improve the function as the finder shutter. As an example, a preferred transmittance is 0.1% or less. A more preferable transmittance is 0.05% or less, and a still more preferable transmittance is 0.01% or less. The above transmittances are examples of threshold values.

An example of the method for improving the performance as the electronic variable ND filter (method for bringing the transmittance close to 0%) includes tuning of the dichroic coating of the beam splitter 50. In this case, for example, the dichroic coating has characteristics of transmitting only a polarization component orthogonal to the polarization direction of the light transmitted through the polarizer 12 (first polarization direction).

### Disposition of Liquid Crystal Panel

Oblique incidence characteristics of the liquid crystal panel 13 change depending on a disposition position of the liquid crystal panel 13. That is, an incidence angle of a ray changes depending on an adjacent optical system. In a case where the performance of the electronic variable ND filter is improved, it is preferable that the incidence angle of the light into the liquid crystal panel 13 (liquid crystal layer) is small.

In a case where the objective optical system 10 includes an optical system having a negative power, an angle of a configuration in which light is emitted from the optical system having the negative power is gentle on the eyepiece side of the optical system having the negative power. Therefore, in a case where the objective optical system 10 includes the optical system having the negative power, it is preferable that the liquid crystal panel 13 is disposed on the eyepiece side of the optical system having the negative power. Accordingly, it is possible to reduce the incidence angle of the ray incident on the liquid crystal panel 13 (liquid crystal layer), and thus improve the performance as the electronic variable ND filter.

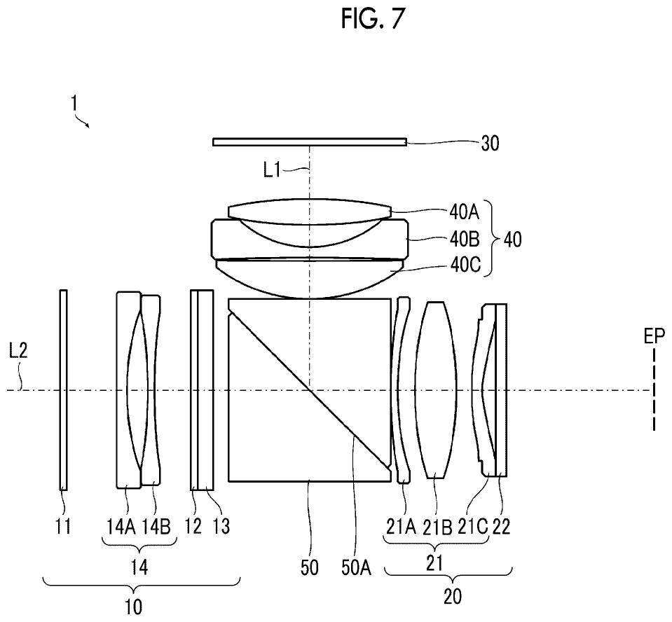

FIG. 7 is a diagram showing an example of the disposition of the liquid crystal panel in a case where the objective optical system includes the optical system having the negative power.

FIG. 7 shows an example of a case where the objective lens group 14 has the negative power. In the example shown in FIG. 7, the polarizer 12 and the liquid crystal panel 13 are disposed between the objective lens group 14 and the beam splitter 50. Accordingly, it is possible to reduce the incidence angle of the ray incident on the liquid crystal panel 13, and thus improve the performance as the electronic variable ND filter. In the present example, the objective lens group 14 is an example of the optical system having the negative power.

On the other hand, in a case where the objective optical system 10 includes an optical system having a positive power, it is preferable to dispose the liquid crystal panel 13 on the objective side of the optical system having the positive power. Accordingly, it is possible to reduce the incidence angle of the ray incident on the liquid crystal panel 13 (liquid crystal layer), and thus improve the performance as the electronic variable ND filter.

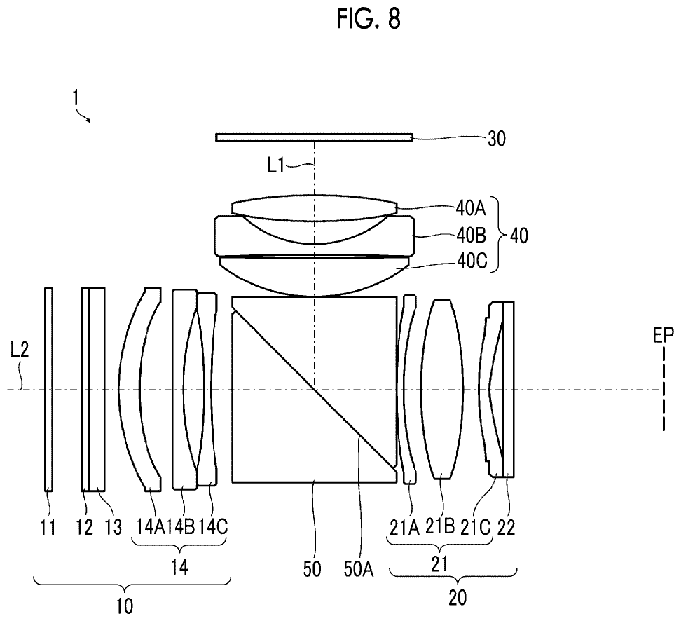

FIG. 8 is a diagram showing an example of the disposition of the liquid crystal panel in a case where the objective optical system includes the optical system having the positive power.

FIG. 8 shows an example in which the objective lens group 14 comprises, in order from the objective side, the first objective lens 14A, the second objective lens 14B, and a third objective lens 14C, along the second optical axis L2, and the first objective lens 14A has the positive power. The polarizer 12 and the liquid crystal panel 13 are disposed on the objective side of the first objective lens 14A. Accordingly, it is possible to reduce the incidence angle of the ray incident on the liquid crystal panel 13, and thus improve the performance as the electronic variable ND filter. In the present example, the first objective lens 14A is an example of the optical system having the positive power.

### Objective Optical System

In a case where the objective optical system 10 includes an optical element made of a resin, birefringence may occur in the optical element. In a case where the birefringence occurs, the object image observed through the OVF is deteriorated (appearance is deteriorated).

In a case where the birefringence occurs due to the polarization, the influence of the birefringence can be suppressed by interposing the optical element causing the birefringence between two quarter-wave plates.

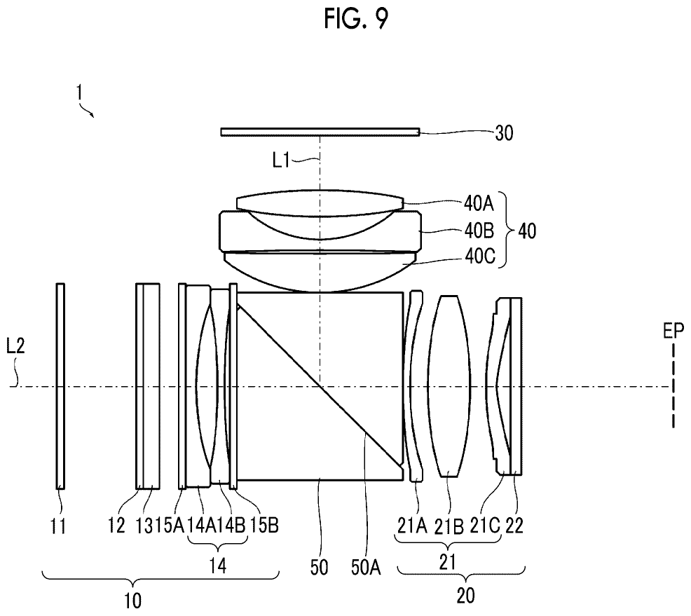

FIG. 9 is a diagram showing an example of a configuration of the HVF in a case where a resin lens is used for the objective lens group.

FIG. 9 shows a configuration in which the objective lens group 14 is disposed between a first quarter-wave plate 15A and a second quarter-wave plate 15B.

Accordingly, even in a case where the resin lens is used for the objective lens group 14, it is possible to suppress the influence of the birefringence, and thus ensure good visibility in the OVF.

### Optical Member That Controls Polarization Direction of Light

In the above embodiment, the case has been described as an example in which the liquid crystal panel 13 (liquid crystal layer) is used as the optical member that controls the polarization direction of the light, but the example of the optical member is not limited thereto. Any member that can control the polarization direction of the light may be employed.

Further, in the above embodiment, the configuration is employed in which the polarization direction of the transmitted light can be controlled for each of the regions (pixels) divided in a matrix shape, but a configuration may be employed in which all the regions are collectively controlled.

### Configuration of Electronic Variable ND Filter

In the above embodiment, the function of the electronic variable ND filter is realized by the polarizer 12, the liquid crystal panel 13, and the beam splitter 50, but the configuration for realizing the function of the electronic variable ND filter is not limited thereto.

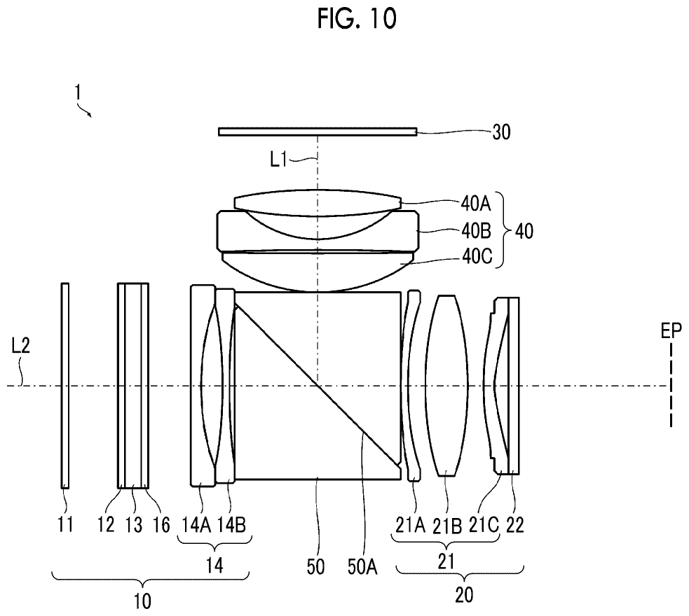

FIG. 10 is a diagram showing another example of the configuration for realizing the function of the electronic variable ND filter.

The HVF 1 shown in FIG. 10 further includes a polarizer 16 between the liquid crystal panel 13 and the beam splitter 50. More specifically, the polarizer 16 is configured to be disposed between the liquid crystal panel 13 and the objective lens group 14, and the liquid crystal panel 13 is configured to be disposed between the two polarizers 12 and 16. Hereinafter, the polarizer 12 disposed on the objective side of the liquid crystal panel 13 is referred to as the first polarizer 12, and the polarizer 16 disposed on the eyepiece side is referred to as the second polarizer 16. Both polarizers will be distinguished from each other.

The first polarizer 12 transmits the light polarized in the first polarization direction. On the other hand, the second polarizer 16 transmits the light polarized in the second polarization direction. The first polarization direction and the second polarization direction have a relationship of being orthogonal to each other.

The polarization direction of the light transmitted through the second polarizer 16 (second polarization direction) is the same as the polarization direction of the light (P-polarized light) transmitted through the beam splitter 50 (second polarization direction).

In the present example, the function of the electronic variable ND filter is realized by the first polarizer 12, the liquid crystal panel 13, and the second polarizer 16.

In the configuration of the above embodiment (configuration of FIG. 1), as compared with the configuration of the present example, the beam splitter 50 also serves as the function of the second polarizer 16, and thus it is possible to simplify the configuration.

On the other hand, in the case of the present example, the beam splitter 50 is not always necessary to be the polarization beam splitter.

### Display Device

In the above embodiment, the organic EL display is used as the display device, but the configuration of the display device is not limited thereto. In addition, for example, a display device such as an LCD, a vacuum fluorescent display (VFD), or a plasma display panel (PDP) can be used.

In a case where a device (for example, LCD) that outputs the polarized light is used as the display device, it is preferable that the polarization direction of the light output from the display device is aligned with the polarization direction of the light reflected by the beam splitter 50.

### Polarizer

In the above embodiment, the prism-type beam splitter is used as the polarizer that performs the light separation and superimposition, but the configuration of the polarizer is not limited thereto. In addition, for example, a half mirror or the like can also be used.

### Digital Camera

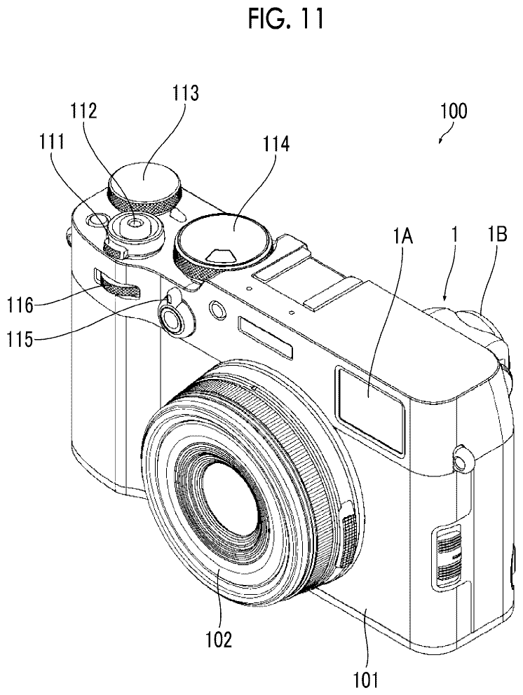

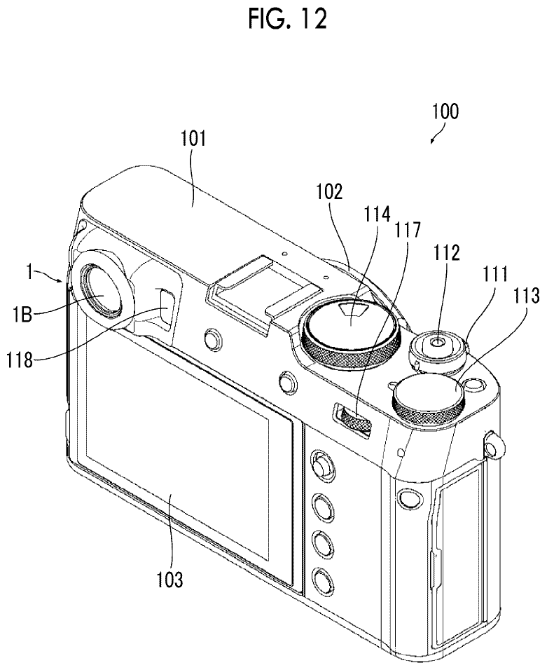

FIG. 11 is a front view of an embodiment of a digital camera to which the present invention is applied. FIG. 12 is a rear perspective view of the digital camera shown in FIG. 11.

A digital camera 100 is a so-called lens-integrated digital camera, and has a configuration in which an imaging lens 102 is integrally attached to a camera body 101. The digital camera 100 is an example of the imaging apparatus.

As shown in FIGS. 11 and 12, the digital camera 100 comprises, on the camera body 101, the imaging lens 102, the hybrid view finder (HVF) 1, a rear monitor 103, various operation members, and the like. The operation member includes a power lever 111, a shutter button 112, an exposure correction dial 113, a shutter speed dial 114, a finder switching lever 115, a front command dial 116, a rear command dial 117, and the like.

The imaging lens 102 is provided on a front of the camera body 101. The imaging lens 102 is composed of a single focus lens having a focus adjustment function.

The HVF 1 is provided at an upper right corner (upper right corner on front surface) of the camera body 101 in FIG. 11. A finder window portion 1A of the HVF 1 is provided on a front surface of the camera body 101, and a finder eyepiece portion 1B of the HVF 1 is provided on a rear surface of the camera body 101. Further, an eye sensor 118 is provided on a rear surface of the camera body 101 adjacent to the finder eyepiece portion 1B. The eye sensor 118 is a sensor that detects proximity of an eye to the finder eyepiece portion 1B (sensor that detects use of the HVF 1).

The rear monitor 103 is provided on the rear surface of the camera body 101. The rear monitor 103 is configured of, for example, the liquid crystal display.

Among the operation members provided in the camera body 101, the finder switching lever 115 is a lever that switches a mode of the HVF 1. The finder switching lever 115 is provided on the front of the camera body 101. The finder switching lever 115 is operated to swing to switch the mode of the HVF 1. Specifically, the OVF and the EVF of the HVF 1 are alternately switched each time the finder switching lever 115 is caused to swing.

### Electric Configuration of Digital Camera

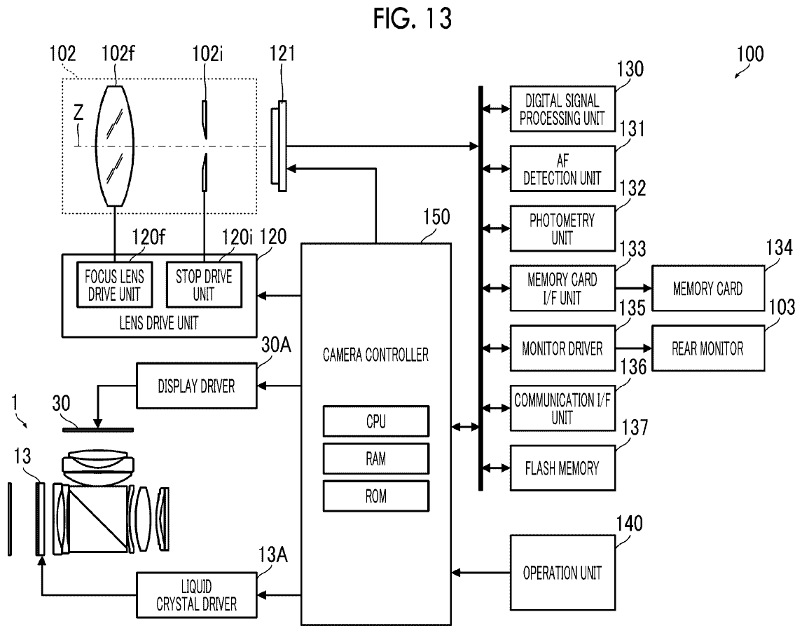

FIG. 13 is a block diagram showing an electric configuration of the digital camera.

As shown in FIG. 13, the digital camera 100 comprises the imaging lens 102, a lens drive unit 120, an image sensor 121, a digital signal processing unit 130, an AF detection unit 131, a photometry unit 132, a memory card interface (I/F) unit 133, a memory card 134, the rear monitor 103, a monitor driver 135, a communication interface (I/F) unit 136, a flash memory 137, an operation unit 140, the finder display 30, a display driver 30A, the liquid crystal panel 13, a liquid crystal driver 13A, a camera controller 150, and the like.

### Imaging Lens and Lens Drive Unit

The imaging lens 102 is composed of a plurality of lenses in combination. The imaging lens 102 has a focus adjustment mechanism, and a lens (focus lens) 102f, which is a part of the imaging lens 102, is moved back and forth along an imaging optical axis Z to perform focus adjustment. Further, the imaging lens 102 comprises a stop 102i, and an opening amount of the stop 102i is adjusted to adjust the amount of light. The stop 102i is composed of, for example, an iris stop.

The lens drive unit 120 comprises a focus lens drive unit 120f that drives the focus lens 102f and a stop drive unit 120i that drives the stop 102i.

The focus lens drive unit 120f moves the focus lens 102f back and forth along the imaging optical axis Z. The focus lens drive unit 120f comprises an actuator, such as a motor, and a drive circuit for the actuator. The focus lens drive unit 120f is controlled by the camera controller 150. The camera controller 150 controls the focus lens drive unit 120f to control the movement of the focus lens 102f.

The stop drive unit 120i expands or contracts an opening portion of the stop 102i. The stop drive unit 120i comprises an actuator, such as a motor, and a drive circuit for the actuator. The stop drive unit 120i is controlled by the camera controller 150. The camera controller 150 controls the stop drive unit 120i to control the opening amount of the stop 102i.

### Image Sensor

The image sensor 121 converts an optical image into an electric signal. For example, a complementary metal oxide semiconductor (CMOS) image sensor having a predetermined color filter array (for example, Bayer array) or a charged coupled device (CCD) image sensor is used as the image sensor 121. As an example, the CMOS color image sensor comprising a drive unit, an analog to digital converter (ADC), a signal processing unit, and the like is used in the digital camera 100 of the present embodiment. In this case, the image sensor 121 is driven by a built-in drive unit to operate. Further, a signal of each pixel is converted into a digital signal by a built-in ADC. Furthermore, the signal of each pixel is subjected to processing, such as sampling two correlation pile processing, gain processing, and correction processing, by a built-in signal processing unit as necessary. The above pieces of signal processing may be configured to be performed before the signal of each pixel is converted into the digital signal, or may be configured to be performed after the signal of each pixel is converted into the digital signal.

### Digital Signal Processing Unit

The digital signal processing unit 130 takes in a signal output from the image sensor 121, and performs predetermined signal processing (for example, gradation transformation processing, white balance correction processing, gamma correction processing, demosaicing, and YC conversion processing) on the signal to generate image data.

### AF Detection Unit

The AF detection unit 131 takes in the signal output from the image sensor 121, and generates information on an evaluation value (focus evaluation value) necessary for auto focus (AF) control.

### Photometry Unit

The photometry unit 132 takes in the signal output from the image sensor 121, and detects the brightness of the subject.

### Memory Card Interface Unit and Memory Card

The memory card interface unit 133 reads and writes data from and to the memory card 134 inserted in a card slot.

### Rear Monitor and Monitor Driver

The rear monitor 103 is used not only for reproducing a captured image, but also as a setting screen for various settings. Further, the rear monitor 103 is used as a live-view monitor by selection of a user. That is, the image captured by the image sensor 121 is displayed on the rear monitor 103 in real time.

The display on the rear monitor 103 is controlled by the camera controller 150. The camera controller 150 controls the display on the rear monitor 103 via the monitor driver 135.

### Communication Interface Unit

The communication interface unit 136 communicates with an external apparatus in a prescribed communication format. The communication is controlled by the camera controller 150.

### Flash Memory

Various types of data necessary for the control of the digital camera 100 and the like are recorded in the flash memory 137.

### Operation Unit

The operation unit 140 outputs a signal in accordance with an operation of the operation member provided in the camera body 101 to the camera controller 150.

### Finder Display and Display Driver

The display of the finder display 30 provided in the HVF 1 is controlled by the camera controller 150. The camera controller 150 controls the display of the finder display 30 via the display driver 30A. The control also includes the control of the amount of light.

### Liquid Crystal Panel and Liquid Crystal Driver

The liquid crystal panel 13 provided in the HVF 1 is driven under the control of the camera controller 150. The camera controller 150 controls the drive of the liquid crystal panel 13 via the liquid crystal driver 13A.

With the control of the drive of the liquid crystal panel 13, the polarization direction of the light transmitted through the liquid crystal panel 13 is controlled, and thus the transmittance of the OVF is controlled. Further, the finder shutter is opened and closed.

### Camera Controller

The camera controller 150 is a controller that integrally controls the overall operation of the digital camera 100. The camera controller 150 is configured of, for example, a computer comprising a central processing unit (CPU) as a processor, and a random access memory (RAM) and a read only memory (ROM) as a memory. That is, the computer executes a predetermined program to function as the camera controller 150.

### Action of Digital Camera

An action of the digital camera 100 focusing on the operation of the HVF 1 will be described.

The user images the subject using the HVF 1 and/or the rear monitor 103. Whether to use the HVF 1 or the rear monitor 103 is determined by the setting of a view mode. The setting of the view mode is performed on, for example, a predetermined setting screen.

The view mode includes a mode in which only the HVF 1 is used, a mode in which only the rear monitor 103 is used, and a mode in which both the HVF 1 and the rear monitor 103 are used. The mode in which both the HVF 1 and the rear monitor 103 are used includes a mode in which the display is automatically switched by the eye sensor 118 and a mode in which the display is always provided on both the HVF 1 and the rear monitor 103. Further, the mode in which only the HVF 1 is used includes a mode in which the display is automatically turned on and off by the eye sensor 118 and a mode in which the display is always turned on.

In a case where the HVF 1 is selected to be used as the view mode, the user images the subject using the HVF 1.

As described above, the HVF 1 of the present embodiment can be used by switching between the OVF and the EVF. The switching between the OVF and the EVF is performed by the finder switching lever 115.

In a case where the EVF is selected, a live view is displayed on the HVF 1 (refer to FIGS. 4A and 4B). In this case, the finder shutter is closed, and the live view is displayed on the finder display 30. Accordingly, HVF 1 functions as the EVF. The user checks an imaging range, a focus state, and the like using the HVF 1 that functions as the EVF.

The closing operation on the finder shutter is performed by the liquid crystal panel 13. That is, the liquid crystal panel 13 controls the polarization direction of the transmitted light to set the transmittance of the light from the objective optical system 10 to be minimum (transmittance is set to 0% or substantially 0%). Accordingly, the light from the objective optical system 10 is blocked, and the finder shutter is closed.

On the other hand, in a case where the OVF is selected, the finder shutter is opened. Accordingly, the object image of the subject is observed through the OVF from the finder eyepiece portion 1B (refer to FIGS. 5A and 5B).

In a case where the OVF is selected, the bright frame BF is displayed on the finder display 30. Further, the imaging information is displayed as necessary. Accordingly, the information displayed on the finder display 30 is displayed in a state of being superimposed on the object image by the OVF.

The opening operation on the finder shutter is performed by the liquid crystal panel 13. That is, the liquid crystal panel 13 controls the polarization direction of the transmitted light to increase the transmittance of the light from the objective optical system 10. Accordingly, the light from the objective optical system 10 is guided to the eyepiece optical system 20, and the finder shutter is opened.

In a case where the OVF is selected, the amount of light of the finder display 30 is controlled, based on the photometry result (subject brightness) of the photometry unit 132, to improve the visibility of the display in the finder. That is, the amount of light is controlled according to the photometry result.

Further, the transmittance of the light from the objective optical system 10 is controlled based on the photometry result of the photometry unit 132. The transmittance is controlled by the liquid crystal panel 13. In this case, the transmittance is lower as the brightness of the subject is higher. That is, the transmittance is decreased in a bright environment, and the transmittance is increased in a dark environment. Accordingly, it is possible to ensure good visibility regardless of the ambient brightness.

It is preferable that the amount of light of the finder display 30 is controlled in conjunction with the change in transmittance. Specifically, it is preferable that a ratio of the amounts of light of the object image of the subject observed through the OVF and the display of the finder display 30 superimposed on the object image is controlled to be always maintained constant. Accordingly, it is possible to maintain good visibility of the display in the finder.

### Modification Example of Imaging Apparatus

In the above embodiment, the case has been described as an example in which the present invention is applied to the lens-integrated digital camera, but the application of the present invention is not limited thereto. The present invention can be similarly applied to an interchangeable-lens-type digital camera.

The HVF 1 may be configured as an external finder to be attachable to and detachable from the camera body.

### Supplementary Note

In the present specification, a meaning of the term “the same” includes not only a meaning of being completely the same but also a meaning of being “substantially the same” including an error allowed in design and manufacturing.

Further, in the present specification, a meaning of the term “orthogonal” includes not only a meaning of “perfectly orthogonal” but also a meaning of “substantially orthogonal” including an error allowed in design and manufacturing.

### Explanation of References

1A: finder window portion
1B: finder eyepiece portion
10: objective optical system
11: quarter-wave plate
12: polarizer (first polarizer)
13: liquid crystal panel
13A: liquid crystal driver
14: objective lens group
14A: first objective lens
14B: second objective lens
14C: third objective lens
15A: quarter-wave plate
15B: quarter-wave plate
16: polarizer (second polarizer)
20: eyepiece optical system
21: eyepiece lens group
21A: first eyepiece lens
21B: second eyepiece lens
21C: third eyepiece lens
22: cover glass
30: finder display
30A: display driver
40: display element-side optical system
40A: first lens
40B: second lens
40C: third lens
50: beam splitter
50A: boundary surface
100: digital camera
101: camera body
102: imaging lens
102f: focus lens
102i: stop
103: rear monitor
111: power lever
112: shutter button
113: exposure correction dial
114: shutter speed dial
115: finder switching lever
116: front command dial
117: rear command dial
118: eye sensor
120: lens drive unit
120f: focus lens drive unit
120i: stop drive unit
121: image sensor
130: digital signal processing unit
131: AF detection unit
132: photometry unit
133: memory card interface unit
134: memory card
135: monitor driver
136: communication interface unit
137: flash memory
140: operation unit
150: camera controller
BF: bright frame
EP: eye point
L1: first optical axis
L2: second optical axis
S: display region
Z: imaging optical axis

What is claimed is:

1. A finder comprising:
a first optical system;
a second optical system including
a first polarizer that transmits light in a first polarization direction, and
an optical member that controls a polarization direction of the light transmitted through the first polarizer; and
a polarizer that reflects at least a part of light passing through the first optical system and transmits light in a second polarization direction in light passing through the second optical system.

2. The finder according to claim 1,
wherein the optical member is a liquid crystal member.

3. The finder according to claim 1,
wherein the first polarizer and the polarizer have a relationship in which a transmittance of the light in the second polarization direction is equal to or less than a threshold value.

4. The finder according to claim 1,
wherein the first polarizer and the polarizer have a relationship in which the first polarization direction intersects with the second polarization direction.

5. The finder according to claim 1,
wherein the polarizer enables a direction of a transmission axis of the polarizer with respect to a transmission axis of the first polarizer to be relatively adjusted.

6. The finder according to claim 5,
wherein the polarizer is rotatable around an optical axis of the second optical system to adjust the direction of the transmission axis of the polarizer with respect to the transmission axis of the first polarizer.

7. The finder according to claim 1,
wherein the second optical system includes an optical system that has a negative power, and
the first polarizer and the optical member are disposed closer to an eyepiece side than the optical system that has the negative power.

8. The finder according to claim 1,
wherein the second optical system includes an optical system that has a positive power, and
the first polarizer and the optical member are disposed closer to an objective side than the optical system that has the positive power.

9. The finder according to claim 1,
wherein the second optical system further includes a first quarter-wave plate and a second quarter-wave plate, and at least one optical element is disposed between the first quarter-wave plate and the second quarter-wave plate.

10. The finder according to claim 9,
wherein the optical element disposed between the first quarter-wave plate and the second quarter-wave plate is an optical element made of a resin.

11. The finder according to claim 1,
wherein the second optical system further includes a second polarizer that transmits the light in the second polarization direction, and the optical member is disposed between the first polarizer and the second polarizer.

12. The finder according to claim 1,
wherein the optical member enables the polarization direction to be controlled for a plurality of regions.

13. The finder according to claim 1
wherein the polarizer is configured of a polarization beam splitter.

14. The finder according to claim 1, further comprising:
a display device,
wherein light emitted from the display device is incident on the first optical system.

15. An imaging apparatus comprising:
the finder according to claim 1.
